(19) United States
(12) Patent Application Publication
(10) Pub. No.: US 2007/0266160 A1
(43) Pub. Date: Nov. 15, 2007

(54) Automatic Application Server Fail Fast and Recover on Resource Error

(76) Inventors: Chris Douglas Johnson, Rochester, MN (US); Kristi Paula Peterson, Rochester, MN (US); John Joseph Stecher, Rochester, MN (US); Matthew Ryan Weaver, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/382,305

(22) Filed: May 9, 2006

(51) Int. Cl. G06F 15/173

(52) U.S. Cl. 709/226

(57) ABSTRACT

Embodiments of the present invention provide methods, systems and apparatus for managing back end problems at a server. Resources at a server may become unavailable for several reasons, for example, due to heavy traffic accessing the resource, errors while running applications, accessing databases, and the like. When requests for accessing such unavailable resources are received, the requests may be immediately failed upon receipt, thereby preventing the server from becoming bogged down with the processing of requests known to access the unavailable resource. Requests associated with available resources may be processed normally. Therefore, by preventing a server from processing requests associated with a known unavailable resource, server performance may be improved.

### BACKGROUND OF THE INVENTION

1. Field of the Invention

The present invention generally relates to data processing, and more specifically to managing back-end problems at a server.

2. Description of the Related Art

In recent years the use of the Internet has revolutionized many aspects of human life, for example, by providing the ability to purchase almost any product at the click of a button, and the ability to exchange messages almost instantaneously via electronic mail. One of the hallmarks of the internet is the client-server architecture. The client server architecture is intended to provide a scalable architecture, wherein each computer in a network is either a client or a server. Client computers may be configured to request services from a server, which in turn may provide the client access to databases, applications, etc. to perform the requested services.

Due to the increasing number of people using the Internet, and the increasing reliance of businesses and consumers on internet based services, the importance of assuring the reliability of servers has greatly increased. However, resources at a server may become unavailable to a requester for a number of reasons, for example, due to an increase in traffic accessing the resource, errors while running applications, and the like.

Current servers have limited ways for dealing with such back-end problems. For example, a request to access a resource may wait for a response until an error or a time-out is received. One problem with the prior art is that each request independently waits for an error or time-out even if a prior similar request had previously failed. As a result, server performance may be severely hampered because of the handling of multiple requests waiting for a known unavailable resource. Furthermore, requests associated with available resources may be denied or handled slowly due to the processing of requests for an unavailable resource. Therefore, the overall effect on server performance can be catastrophic when a resource becomes unavailable.

Accordingly, what is needed are improved methods, systems and apparatus to handle back end problems at a server.

### SUMMARY OF THE INVENTION

The present invention generally relates to data processing, and more specifically to managing back-end problems at a server.

One embodiment of the invention provides a method for managing requests received by a server. The method generally comprises receiving, from a client, a request to perform a service provided by the server, wherein performing the service comprises accessing a resource of the server associated with the request, and determining whether the resource associated with the request is identified as unavailable according to predefined information indicative of the unavailability of one or more resources, thereby avoiding the need to attempt to access the resource associated with the request. The method further comprises, in response to determining that the resource associated with the request is identified as unavailable, failing the request without attempt to access the resource associated with the request.

Another embodiment of the invention provides a computer readable medium containing a program for managing requests received by a server which, when executed by a processor, performs one or more operations. The operations generally comprise receiving, from a client, a request to perform a service provided by the server, wherein performing the service comprises accessing a resource of the server associated with the request, and determining whether the resource associated with the request is identified as unavailable according to predefined information indicative of the unavailability of one or more resources, thereby avoiding the need to attempt to access the resource associated with the request. The method further comprises, in response to determining that the resource associated with the request is identified as unavailable, failing the request without attempt to access the resource associated with the request.

Yet another embodiment provides A system, comprising a client and a server computer. The client is generally configured to issue requests for services. The server is generally configured to receive, from the client, a request to perform a service provided by the server, wherein performing the service comprises accessing one or more resources of the server associated with the request, determine whether a resource associated with the request is identified as unavailable according to predefined information indicative of the unavailability of the one or more resources, thereby avoiding the need to attempt to access the resource associated with the request, and in response to determining that the resource associated with the request is identified as unavailable, fail the request without attempt to access the resource associated with the request.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system in which embodiments of the invention may be implemented.

FIG. 2 is a flow diagram of exemplary operations performed to enter into fail fast mode, according to an embodiment of the invention.

FIG. 3 is a flow diagram of exemplary operations performed in the fail fast mode, according to an embodiment of the invention.

FIG. 4 is a flow diagram of exemplary operations performed by a health monitor to maintain the status of resources in fail fast mode, according to one embodiment of the invention.

FIG. 5 is an exemplary mapping structure according to an embodiment of the invention.

### DETAILED DESCRIPTION OF THE PREFERRED EMBODIMENTS

Embodiments of the present invention provide methods, systems and apparatus for managing back end problems at a server. Resources at a server may become unavailable for several reasons, for example, due to heavy traffic accessing the resource, errors while running applications, accessing databases, and the like. When requests for accessing such unavailable resources are received, the requests may be immediately failed upon receipt, thereby preventing the server from becoming bogged down with the processing of requests known to access an unavailable resource. Requests associated with available resources may be processed normally. Therefore, by preventing a server from processing requests associated with a known unavailable resource, server performance may be improved.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

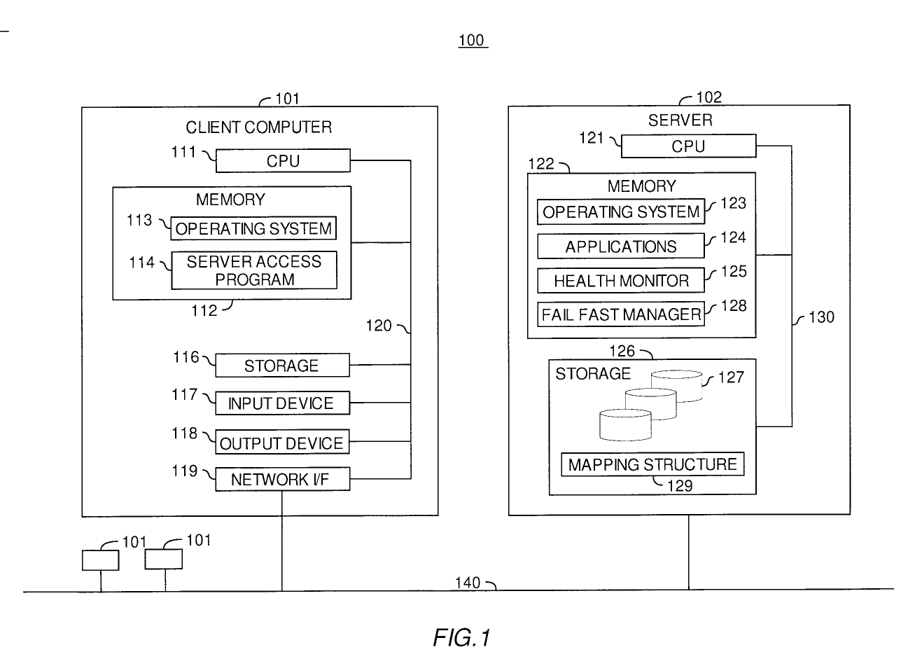

One embodiment of the invention is implemented as a program product for use with a computer system such as, for example, the computer system 100 shown in FIG. 1 and described below. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

An Exemplary System

FIG. 1 depicts a block diagram of a networked system 100 in which embodiments of the present invention may be implemented. In general, the networked system 100 includes a Client (e.g., user's) computer 101 (three such client computers 101 are shown) and at least one server 102 (one such server 102 shown). The client computers 101 and server 102 are connected via a network 140. In general, the network 140 may be a local area network (LAN) and/or a wide area network (WAN). In a particular embodiment, the network 140 is the Internet.

The client computer 101 includes a Central Processing Unit (CPU) 111 connected via a bus 120 to a memory 112, storage 116, an input device 117, an output device 118, and a network interface device 119. The input device 117 can be any device to give input to the client computer 101. For example, a keyboard, keypad, light-pen, touch-screen, track-ball, or speech recognition unit, audio/video player, and the like could be used. The output device 118 can be any device to give output to the user, e.g., any conventional display screen. Although shown separately from the input device 117, the output device 118 and input device 117 could be combined. For example, a display screen with an integrated touch-screen, a display with an integrated keyboard, or a speech recognition unit combined with a text speech converter could be used.

The network interface device 119 may be any entry/exit device configured to allow network communications between the client computers 101 and server 102 via the network 140. For example, the network interface device 119 may be a network adapter or other network interface card (NIC).

Storage 116 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 112 and storage 116 could be part of one virtual address space spanning multiple primary and secondary storage devices.

The memory 112 is preferably a random access memory sufficiently large to hold the necessary programming and data structures of the invention. While the memory 112 is shown as a single entity, it should be understood that the memory 112 may in fact comprise a plurality of modules, and that the memory 112 may exist at multiple levels, from high speed registers and caches to lower speed but larger DRAM chips.

Illustratively, the memory 112 contains an operating system 113. Illustrative operating systems, which may be used to advantage, include Linux and Microsoft's Windows®. (Note: Linux is a trademark of Linus Torvalds in the US, other countries, or both.) More generally, any operating system supporting the functions disclosed herein may be used.

The memory 112 is also shown containing a server access program 114 that, when executed by CPU 111, provides support for accessing a server 102. In one embodiment, the server access program 114 includes a web-based Graphical User Interface (GUI), which allows the user to display Hyper Text Markup Language (HTML) information. More generally, however, the server access program 114 may be a GUI-based program capable of rendering the information transferred between the client computer 102 and the server 102.

The server 102 may be any type of server including, but not limited to, an application server, a mail server, and a web server. Server 102 may be physically arranged in a manner similar to the client computer 101. Accordingly, the server 102 is shown generally comprising a CPU 121, a memory 122, and a storage device 126, coupled to one another by a bus 130. Memory 122 may be a random access memory sufficiently large to hold the necessary programming and data structures that are located on the server 102.

The server 102 is generally under the control of an operating system 123 shown residing in memory 122. Examples of the operating system 123 include IBM OS/400®, UNIX, Microsoft Windows®, and the like. More generally, any operating system capable of supporting the functions described herein may be used.

The memory 122 further includes one or more applications 124, fail fast manager 128, and health monitor 125. Applications 124 may be configured to provide one or more services to client computer 101 in response to receiving a request from client 101 over network 140. The applications 124 are software products comprising a plurality of instructions that are resident at various times in various memory and storage devices in the computer system 100. For example, applications 124 may contain a query interface. The query interface (and more generally, any requesting entity, including the operating system 123) is configured to issue queries against a database 127 (shown in storage 126).

The databases 127 are representative of any collection of data regardless of the particular physical representation. By way of illustration, the databases 127 may be organized according to a relational schema (accessible by SQL queries) or according to an XML schema (accessible by XML queries). However, the invention is not limited to a particular schema and contemplates extension to schemas presently unknown. As used herein, the term “schema” generically refers to a particular arrangement of data.

Storage 126 may also contain a mapping structure 129. Mapping structure 129 may be a data structure, for example, a table, linked list, or the like, containing a mapping between types of request handled by the server and the resources accessed by each type of request. In some embodiments, mapping structure 129 may also contain status information for resources at the server. For example, the mapping structure may indicate whether the resource is available.

Fail fast manager 128 may be configured to determine whether a given resource at server 102 has become unavailable. If a resource becomes unavailable, fail fast manager 128 may be configured to fail subsequent requests associated with the resource, thereby avoiding the need to attempt to access the resource. Fail fast manager 128, for example, may access mapping structure 129 to determine whether a received request is associated with an unavailable resource. Details of operations performed to enter into the fail fast mode and to fail the subsequent requests associated with an unavailable resource are provided in greater detail below.

Health monitor 125 may be configured to maintain the status resources within server 102. Illustrative resources include applications 124 and databases 127. In one embodiment, health monitor 125 may check the availability of resources, periodically and update the status information for the resources. For example, if a database that was previously identified as unavailable becomes available, health monitor 125 may be configured to re-enable requests associated with the database, thereby removing the requests from fail fast mode.

Client Server Communication

Users at clients 101 may request the use of one or more applications and/or services provided by a server 102. For example, a client 101 may launch server access program 114 to access an application or service provided by server 102. In one embodiment, server access program 114 may be a web browser configured send a request for a web page to server 102. Requesting a web page, for example, may include entering a Uniform Resource Locator (URL) in a web browser. The web browser may receive a response from server 102 containing the contents of a web page, and display the contents in a graphical user interface at the client computer 101.

A web page may contain dynamic content. Dynamic content may include images, text, and other fields that may change or move without the page being reloaded. The dynamic content may be implemented using applets, servlets, and the like, well known to those skilled in the art. Each servlet or applet may be configured to perform a distinct task. Implementing the dynamic content may include requesting access to resources at server 102. For example, displaying the web page may include playing a tune in the background while the user is viewing the web page. A servlet may access a music file at server 102 to play the tune as the user views the contents of the web page.

In response to receiving requests from a client 101, server 102 may access one or more resources at Server 102. For example, server 102 may launch one or more applications 124 or access one or more databases 127, retrieve contents of the web page, etc. A response may be provided to the client's request. For example, the contents of a web page may be sent to the client computer.

In some embodiments server 102 to may retrieve data associated with the request from an external source. Server 102 may establish a connection with a second server to retrieve data associated with a request from the second server. For example, in one embodiment, server 102 may be a mail server associated with a client 101. Client 101 may launch an email program (another example of a server access program 114) and request server 102 for the contents of an email that the user desires to view. In response to receiving the request, server 102 may establish a connection with a second mail server containing the contents of the email. The contents of the email may be retrieved from the second mail server and provided to client 101.

A server access program, for example, a web browser or an email program, may launch multiple tasks simultaneously by executing a separate thread for each task. For example, in the web browser described above, a first thread may execute the servlet playing a tune while the user views web content. The thread may access, for example, the music file containing the tune. In the same browser, other threads may access other resources and perform other distinct tasks such as displaying animations, retrieving data from a database in response to user input, and the like.

When multiple users access the same web page, multiple threads of the same type may be generated. For example, multiple client computers 101 may launch a web browser and request the web page described above. Each web browser may launch its own respective thread to play background music. Each thread that performs the same task may follow the same program path and access the same resources. For example, the multiple background music threads may each access the same music file to play the background tune in their respective browser.

Fail Fast Mode

One skilled in the art will recognize that resources at a server may become unavailable for several reasons. For example, the server may become overloaded with a large number of requests to access a particular resource, for example, an application 124 or database 127. The server may not be capable of handling the large number of requests. Therefore, the particular resource may become unavailable to current and subsequent requests. In another example, server 102 may be unable to establish a connection with a second server to access external resources because the external resources may have become unavailable. Therefore, the server may be unable to provide the service requested to one or more clients.

When multiple requests of the same type are received, the threads associated with the request may follow the same paths and attempt to access the same resources even if a resource is known to be unavailable. For example, each thread may independently execute the same instructions along a program path that accesses an unavailable resource. Each of the same threads associated with an unavailable resource may stall or eventually receive an error. For example, in some embodiments, inability to access a resource within a timeout period may generate an error.

However, processing requests that are known to access an unavailable resource may greatly slow down server response and prevent the effective processing of requests associated with available resources. To prevent the server from becoming bogged down with processing requests that are known to result in a failure, embodiments of present invention provide for the immediate failing of threads that are associated with a known unavailable resource upon receipt.

Failing immediately, or failing fast, requests associated with an unavailable resource may include, for example, identifying poisoned or failing code paths that may be executed by a thread associated with a type of request. Executing poisoned or failing code paths, for example, may involve executing one or more instructions which may access the unavailable resource. By preventing execution of such code that is bound to result in failure, valuable processing time may be saved and performance improved.

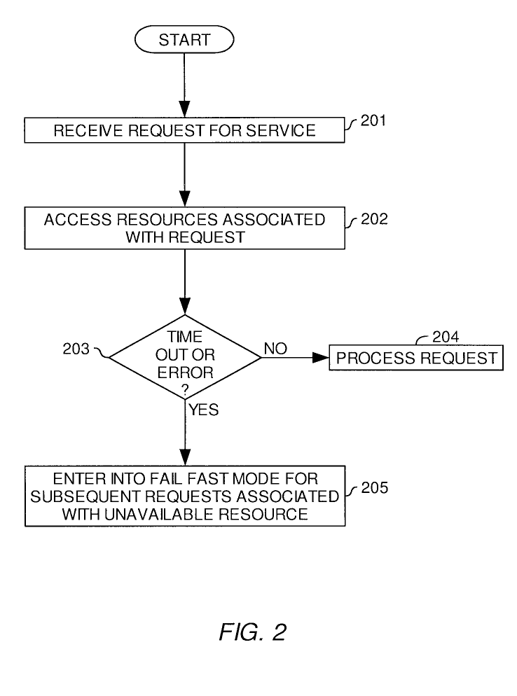

FIG. 2 is a flow diagram of exemplary operations performed by fail fast manager 128 to enter into fail fast mode for requests associated with an unavailable resource. The operations begin in step 201 by receiving a request for a service. The request may be associated with a thread configured to execute a servlet. For example, the background music servlet described above. In response to receiving the request, one or more resources associated with the request may be accessed in step 202. For example, with reference to the background music servlet, a music file containing the tune may be accessed.

In step 203, if the resource is unavailable, an error or timeout may be detected. For example, there may be too many threads accessing the music file, thereby preventing subsequent requests from being serviced. If a certain predefined period of time expires and the request is provided access to a resource, a timeout may occur indicating that the resource is unavailable. In another example, an error condition may be generated if a failed resource is accessed. For example, if the request involves accessing a database, an error may be generated if the database machine is not functioning.

If an error is not detected in step 203, the request may be processed by accessing the resource in step 204. On the other hand, if an error or timeout is detected, any subsequent requests of the same type that are received may be configured to fail fast in step 205. For example, if the music file becomes unavailable, any subsequent request that accesses the music file may be immediately failed.

While failing same requests that access the unavailable resource is disclosed above, one skilled in the art will recognize that other distinct types of requests that access the unavailable resource may also be set to fail fast in step 205. For example, a first type of request may access a given resource. If the given resource becomes unavailable, the first type of request may be configured to fail fast in response to a first type of request receiving an error or timeout. Furthermore, if a second type of request also accesses the given resource, subsequent second type of requests may also be configured to fail fast in response to a first type of request receiving a failure or timeout.

The determination of the types of requests that are set to fail fast mode may depend on a mapping of request types to resources. One skilled in the art will recognize that for each type of request a list of resources accessed by that type of request may be determined. Furthermore, different types of requests may access the same resource. Therefore, when a resource becomes unavailable, the types of requests mapped to the resource may be configured to fail fast.

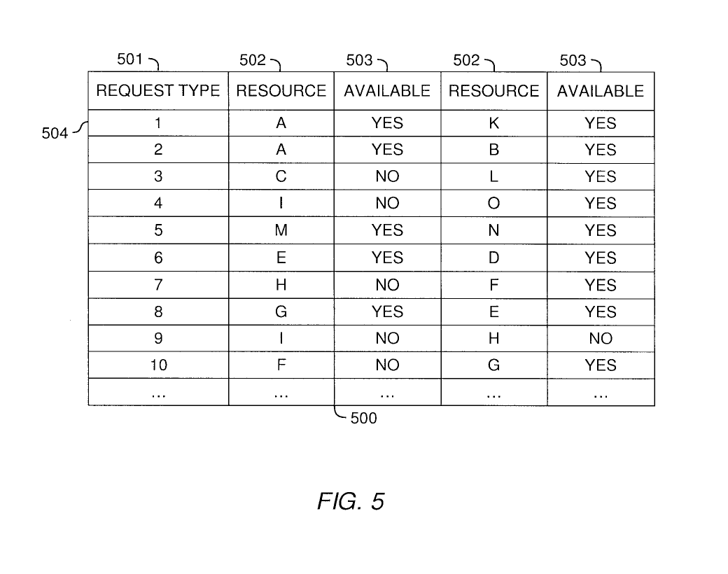

FIG. 5 illustrates an exemplary mapping structure 129, according to an embodiment of the invention. Mapping structure 129 may be a table, however, one skilled in the art will recognize that any appropriate data structure may be used. Mapping structure 129 may include a request type field 501, one or more resource fields 502, and one or more status fields 503 associated with each resource field 502.

Request type field 501 may contain a list of request types that may be received and services by a server. Each type of request may be configured to access the same resources. For example, all requests of type 1 may access resources A and K as illustrated by row 504. Resource fields 502 may list the resources accessed by a given type of request. While two resource fields 502 are shown in FIG. 5, one skilled in the art will recognize that any number of resources may be associated with a type of requests. Accordingly, any number of resource fields 502 may be provided.

Status fields 502 may contain the availability status of resources listed in resource fields 502. For example, resource A is shown as available, and resource H is shown as unavailable in FIG. 5. One skilled in the art will recognize that, status field 503 may be excluded from mapping structure 129. If excluded, a separate data structure may be provided containing a list of resources and their availability status. Furthermore, embodiments of the invention are not limited by the implementation of the data structure in FIG. 5. One skilled in the art will recognize that any appropriate data structure or structures may be implemented to map a request type with resources accessed by the request type and to keep track of status information of the resources.

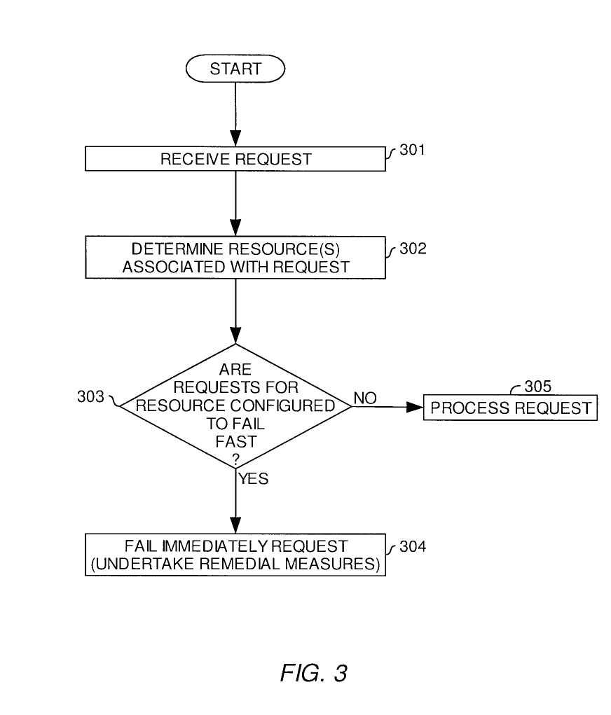

FIG. 3 is a flow diagram of exemplary operations performed by fail fast manager 128 in the fail fast mode. The operations begin in step 301 by receiving a request. In step 302, the resources mapped to the request may be determined. In step 303, if one or more resources mapped to the request are known to be unavailable, the request may be immediately failed in step 304. On the other hand, if the request is not mapped to an unavailable resource, the request may be processed in step 205 by accessing the available resources associated with the request.

If an unavailable resource subsequently becomes available, requests associated with the resource may be taken out of fail fast mode and re-enabled. A health monitor daemon, for example, Health Monitor 125 illustrated in FIG. 1, may run in the background to determine the status of resources at server 102. The health monitor may be configured to check the status of each resource repetitively at the end of a predefined period of time. The time period may be user configurable and, therefore, may be set by a system administrator to an appropriate frequency for resource status checking. For example, in an exemplary embodiment, Health Monitor 125 may check the status of resources at the server every one minute. In response to determining that a previously unavailable resource has become available, Health Monitor 125 may re-enable requests associated with the resource.

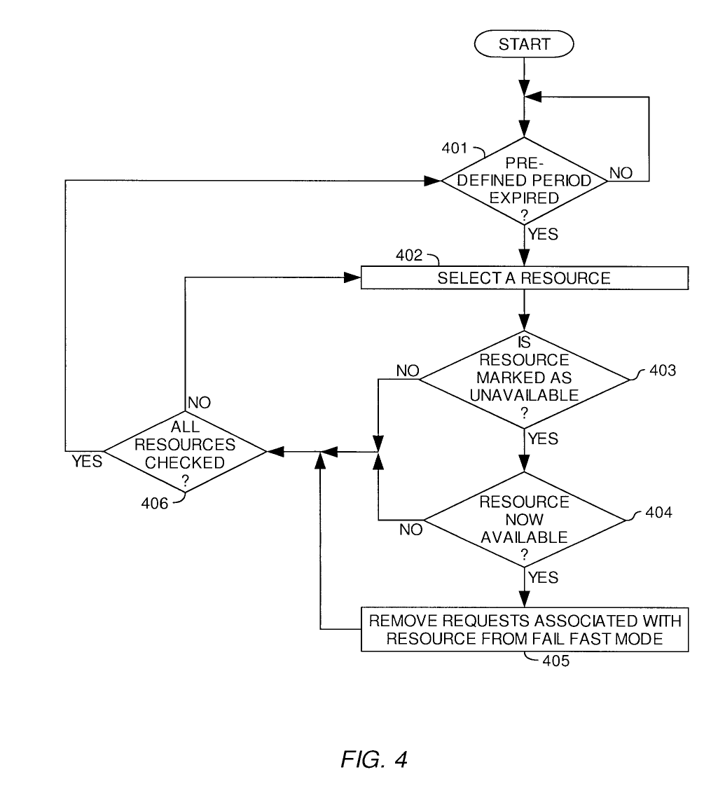

FIG. 4 is a flow diagram of exemplary operations performed by the health monitor to determine the status of resources. The operations begin in step 401 by determining whether a predefined time period has expired. For example, in some embodiments, the health monitor may maintain utilize a timer to determine whether the predefined time period has completed. The predefined time period may be user configurable and may be set to any reasonable period to set an appropriate frequency of resource status checks.

In step 401 the health monitor may stall until the predefined time period has expired. When the predefined time period expires, the health monitor may select a resource in step 402. In step 403, the health monitor may determine whether the resource was previously marked unavailable. If the resource was not marked as unavailable the health monitor may go to step 406. On the other hand, if a resource was marked as unavailable, the health monitor may determine if the resource is now available in step 404. If the resource is not available, the health monitor may go to step 406.

If the resource that was previously unavailable is determined to be available in step 404, the requests associated with the resource may be removed from fail fast mode and re-enabled in step 405. The health monitor may then proceed to step 406. At step 406, the health monitor may determine if all resources have been checked. If all resources have been checked, the health monitor may return to step 401. On the other hand, if it is determined that all resources have not been checked, the health monitor may go to step 402 to select a next resource.

In some embodiments, entering fail fast mode may allow for the immediate notification of the erroneous condition to the user. For example, when a resource becomes unavailable and a request associated with the unavailable resource is failed fast, the user may receive a notification regarding the availability of the resource. Therefore, the user may be immediately notified about the unavailability of the resource without having to wait for possibly long timeout periods. In some embodiments, the user may queue failed requests. When the resources associated with the failed requests become available, the requests may be then be reissued.

In other embodiments, entering the fail fast mode may allow for the undertaking of remedial measures to overcome the unavailability of a resource at a server. For example, if the resources at a first server become unavailable, client requests may be routed to a second server where resources are available.

Conclusion

By allowing requests associated with a known unavailable resource to be failed immediately, embodiments of the present invention prevent servers from becoming bogged down with the processing of requests that are bound to fail. Therefore, server processing time may be efficiently utilized and performance improved. Furthermore, processing of requests associated with available resources may continue normally without being affected by other failing resources.

While the foregoing is directed to embodiments of the present invention, other and further embodiments of the invention may be devised without departing from the basic scope thereof, and the scope thereof is determined by the claims that follow.

What is claimed is:

1. A method for managing requests received by a server, comprising:
receiving, from a client, a request to perform a service provided by the server, wherein performing the service comprises accessing a resource of the server associated with the request;
determining whether the resource associated with the request is identified as unavailable according to predefined information indicative of the unavailability of one or more resources, thereby avoiding the need to attempt to access the resource associated with the request; and
in response to determining that the resource associated with the request is identified as unavailable, failing the request without attempt to access the resource associated with the request.

2. The method of claim 1, further comprising, if the resource is identified as available and the request is found to actually be unavailable, identifying the resource as unavailable.

3. The method of claim 2, wherein the resource is actually unavailable if the request is not accessed within a predefined time period.

4. The method of claim 2, wherein the resource is actually unavailable if accessing the resource generates an error condition.

5. The method of claim 1, further comprising, if the request is identified as unavailable and the resource is actually available, identifying the resource as available.

6. The method of claim 1, wherein the server is a web server.

7. The method of claim 1, wherein accessing the resource comprises establishing a connection between the server and a second server, wherein the second server is configured to provide access to an external resource at the second server.

8. A computer readable medium containing a program for managing requests received by a server which, when executed by a processor, performs operations comprising:
receiving, from a client, a request to perform a service provided by the server, wherein performing the service comprises accessing a resource of the server associated with the request;
determining whether the resource associated with the request is identified as unavailable according to predefined information indicative of the unavailability of one or more resources, thereby avoiding the need to attempt to access the resource associated with the request; and
in response to determining that the resource associated with the request is identified as unavailable, failing the request without attempt to access the resource associated with the request.

9. The computer readable medium of claim 8, wherein the operations further comprise, if the resource is identified as available and the request is found to actually be unavailable, identifying the resource as unavailable.

10. The computer readable medium of claim 9, wherein the resource is actually unavailable if the request is not accessed within a predefined time period.

11. The computer readable medium of claim 9, wherein the resource is actually unavailable if accessing the resource generates an error condition.

12. The computer readable medium of claim 8, wherein the operations further comprise, if the request is identified as unavailable and the resource is actually available, identifying the resource as available.

13. The computer readable medium of claim 8, wherein the server is a web server

14. The computer readable medium of claim 8, wherein accessing the resource comprises establishing a connection between the server and a second server, wherein the second server is configured to provide access to an external resource at the second server.

15. A system, comprising:
a client configured to issue requests for services; and
a server configured to:
receive, from the client, a request to perform a service provided by the server, wherein performing the service comprises accessing one or more resources of the server associated with the request;
determine whether a resource associated with the request is identified as unavailable according to predefined information indicative of the unavailability of the one or more resources, thereby avoiding the need to attempt to access the resource associated with the request; and
in response to determining that the resource associated with the request is identified as unavailable, fail the request without attempt to access the resource associated with the request.

16. The system of claim 15, wherein the server is further configured to identify the resource as unavailable if the resource is identified as available and the request is found to actually be unavailable.

17. The system of claim 16, wherein the resource is actually unavailable if the request is not accessed within a predefined time period.

18. The system of claim 16, wherein the resource is actually unavailable if accessing the resource generates an error condition.

19. The system of claim 15, further comprising a health monitor configured to identify the resource as available if the request is identified as unavailable and the resource is actually available.

20. The system of claim 19, wherein the health monitor is configured to check the status of resources at the server repetitively after the end of a predefined time period.
